(19) United States
(12) Patent Application Publication
(10) Pub. No.: US 2008/0011122 A1
(43) Pub. Date: Jan. 17, 2008

(54) Crankshaft for an internal combustion engine

(76) Inventor: Hubert Singer, Utzmemmingen (DE)

Correspondence Address: GRAYBEAL, JACKSON, HALEY LLP, 155 - 108TH AVENUE NE, SUITE 350, BELLEVUE, WA, 98004-5973, US

(21) Appl. No.: 11/707,556

(22) Filed: Feb. 15, 2007

Related U.S. Application Data
(63) Continuation-in-part of application No. PCT/EP05/05611, filed on May 24, 2005.

(30) Foreign Application Priority Data
Aug. 18, 2004 (DE) 10 2004 040 171.3

(51) Int. Cl. F16C 3/06

(52) U.S. Cl. 74/597

(57) ABSTRACT

The invention relates to a crankshaft (1) for an internal combustion engine, comprising at least one crank pin (4) which is arranged between two faces (3) which are connected together by means fo a shaft journal (2). The aim of the invention is to ensure that the crank pin bearings are lubricated without weakening the static and dynamic bearing capacity of the crankshaft. The crank pin (4) and also at least one of the shaft journals (2) comprise cavities (11, 16) and the cavities (11, 16) are connected together by means of a line (12) which extends essentially on the outside of the faces (3).

The present invention relates to a crankshaft for an internal combustion engine, comprising at least one crankpin journal which is arranged between two cheeks which are connected in each case to a shaft journal, and to an internal combustion engine having a crankshaft of this type.

Crankshafts are usually mounted in such a way that both the shaft journal or the shaft journals and the crankpin journal or the crankpin journals are mounted by way of sliding bearings. Sliding bearings of this type require a sufficient supply of lubricating oil, with the result that the sliding bearing can build up a sufficient oil pressure. The shaft journal bearings are usually supplied externally with lubricating oil which is provided by an oil pressure pump, and oil is supplied to the crankpin journal bearing as a result of the lubricating oil pressure in the shaft journal bearing via the supply hole which is drilled through the crankshaft and, in particular, through a cheek of the crankshaft there and ends in the crankpin journal.

### PROBLEMS OF THE PRIOR ART

A disadvantage of known crankshafts having oil supply holes of this type is, in particular, that, on account of the geometric arrangement of crankpin journal and shaft journal, the hole has to be routed through regions of the cheek which assumes a substantial transmission function for the static and dynamic forces which occur. The crankshaft is therefore weakened overall in terms of its loadability as a result of known holes for oil supply.

It is therefore an object of the present invention to provide a crankshaft, in which lubrication, in particular of the crankpin journal bearing, can be ensured without weakening of the static and dynamic loadability of the crankshaft.

### ADVANTAGES OF THE INVENTION

This problem is solved by a crankshaft and an internal combustion engine as claimed in the independent claims. The problem is solved, in particular, by a crankshaft for an internal combustion engine, comprising at least one crankpin journal which is arranged between two cheeks which are connected in each case to a shaft journal, characterized in that both the crankpin journal and at least one of the shaft journals have hollow spaces, the hollow spaces being connected to one another by means of a pipe duct which extends substantially outside the cheeks. The hollow spaces both of the crank journal and of the shaft journal are, for example, depressions which are made first of all in the context of the casting process of the individual parts and are subsequently shaped further with processing steps which remove material. Both the crank journal and the shaft journal are therefore of substantially hollow-cylindrical design; in order to achieve a mechanical loadability which is as great as possible, transitions of a known type should be made, namely as far as possible without edges and without great changes in cross section. The pipe ducts are subsequently attached thin, preferably flexible pipe ducts which are, for example, metallic or else made from plastic and connect the hollow spaces of the crank journal and the shaft journal to one another. To this end, the pipe ducts are clamped in, welded in, adhesively bonded in or fixed on or in the holes by way of known fastening means, such as screw fastening means. Apart from the connecting holes to the hollow spaces of the crank journal and the shaft journal, the pipe ducts extend substantially outside the crankshaft, in particular outside the cheeks, with the result that no holes are to be made through the cheeks in such a form that they connect the hollow spaces of the shaft journal and of the crank journal directly to one another as continuous rectilinear holes or by a plurality of hole lengths which extend at an angle with respect to one another. In this way, it is ensured that the cheeks per se are not weakened, in particular on a connecting line between the center lines of the shaft journal and the crank journal, on which a substantial part of the force transmission occurs between the two.

In one development, there is provision for the crankshaft to comprise a plurality of right-angled bends having in each case one cheek, one crankpin journal and a further cheek, the right-angled bends being screwed to one another in each case and each hollow space of a crankpin journal being connected to the hollow space of a shaft journal by means of a pipe duct. Here, this is a multiple-part crankshaft for a plurality of cylinders, in each case the sequence cheek-crankpin journal-cheek being understood as a right-angled bend and each crankpin journal being connected to a connecting rod or, for example in the case of a V engine, to a plurality of connecting rods for in each case one piston of a cylinder. The right-angled bends can therefore be manufactured as individual parts and connected to one another only subsequently. Here, there is advantageously provision for the right-angled bends to comprise in each case one shaft journal connection, regions of the shaft journal connection being provided with toothing systems which correspond with one another, and other regions of the shaft journal connection being without toothing, with the result that the regions without toothing form passages between hollow spaces of the shaft journals and the outer faces of the shaft journals. Here, the toothing systems are configured in such a way that they can be screwed to one another at different angles (with regard to the rotational axis of the crankshaft). Here, there can also be provision for it to be possible for the toothing systems to be connected to one another only at a defined angle, with the result that faulty mounting of the crankshaft can be avoided. Those sections of the shaft journal connection without toothing form passages which can convey a lubricating oil from the sliding bearing of the respective shaft journal into the associated hollow space and further to the assigned crank journal via the pipe ducts.

In one development of the crankshaft, there is provision for the right-angled bends to be connected to one another by way of a threaded pin which has a right-handed thread on one axial side and a left-handed thread on the other side. As a result of the use of a pin having a right-handed thread and a left-handed thread, the pin can be screwed in from one side and in the process at the same time presses the parts which are to be connected to one another onto one another. It is advantageous here if at least one of the threads of the threaded pin is self-locking. Here, the self-locking action is configured in such a way that the self-locking character is preserved even under the influence of a lubricating oil, with the result that further securing means can be omitted. As an alternative, the pin can also be fixed, for example, by staking, welding or similar measures.

In one preferred alternative refinement, there is provision for the right-angled bends to be connected to one another by way of a threaded pin which has in each case right-handed or left-handed threads of different pitch on both sides. The overall pitch during screwing together then results as the difference of both thread pitches. If, for example, one side has a pitch of 1.5 mm and the other has a pitch of 1.0 mm, the effective pitch is 0.5 mm, that is to say the distance which both parts which are to be screwed together are moved toward one another during one pin revolution. The effective pitch is critical for the self-locking action as the difference of the pitches of the two threads.

In one development of the crankshaft, there is provision for the pipe duct to open into the shaft journal outside the force flow of the cheeks. This means, in particular, that the connecting hole, by way of which the pipe duct is connected to the hollow space of the shaft journal, is not routed in regions of the cheek which lies in the region of the force flow between the journal and the crankpin journal, for example therefore on a direct connecting line or in a region parallel to a direct connecting line between the two.

There is preferably provision for the pipe duct to open into the crank journal outside a surface which represents the intersection of two circles about the rotational axes of the crank journal and the shaft journal with the radius of the spacing between the two axes. The pipe ducts open in each case outside this surface into the cheeks or crank journal.

There is preferably provision for the pipe duct to open into a sealing cap of the crank journal. The sealing cap can be manufactured, for example, from a plastic or a metal plate and does not take part itself in the transmission of force.

There is preferably provision for the pipe duct to be fixed to the cheek by way of at least one holding device. The holding device can be configured, for example, as a clamping holding device, as a screwing holding device or the like and prevents the pipe duct from being deformed excessively during operation of the crankshaft, that is to say when the crankshaft rotates (quickly). In addition, (resonant) oscillations of the pipe duct can be suppressed in a targeted manner, with the result that they are suppressed or damped (to a pronounced extent) at the operating rotational speeds of the crankshaft.

As an alternative or in addition to the screwing means, there can be provision for the right-angled bends to be welded to one another or to be connected in another way with a material-to-material fit, for example soldered or adhesively bonded. As a result, a pin for connecting the cheeks can be omitted and further weight saving can therefore be achieved.

Instead of a pipe duct which extends substantially outside the cheeks, there can be provision for a hole to be routed from the hollow space centrally through the cheek into the crankpin journal hollow space. The hole therefore lies in a region which is weakened only slightly by it, as the section modulus is reduced only insubstantially by the hole. The hole lies substantially in a zone which is neutral with regard to the flexural loading of the crankshaft.

The problem which was mentioned in the introduction is also solved by an internal combustion engine having the crankshaft as claimed in one of the claims of the present invention which are directed at the crankshaft.

### DRAWINGS

In the following text, one exemplary embodiment of the present invention will be explained in greater detail using the appended drawings, in which:

FIG. 1 shows a three-dimensional illustration of a crankshaft;

FIG. 2 shows a three-dimensional illustration of a right-angled bend;

FIG. 3 shows the illustration from FIG. 2 from a different perspective;

FIG. 4 shows a partial longitudinal section through a crankshaft having a pipe duct which lies on the outside;

FIG. 5 shows a partial longitudinal section through a crankshaft having a hole through the cheeks; and

FIG. 6 shows a three-dimensional illustration of a cheek according to the embodiment as per FIG. 5.

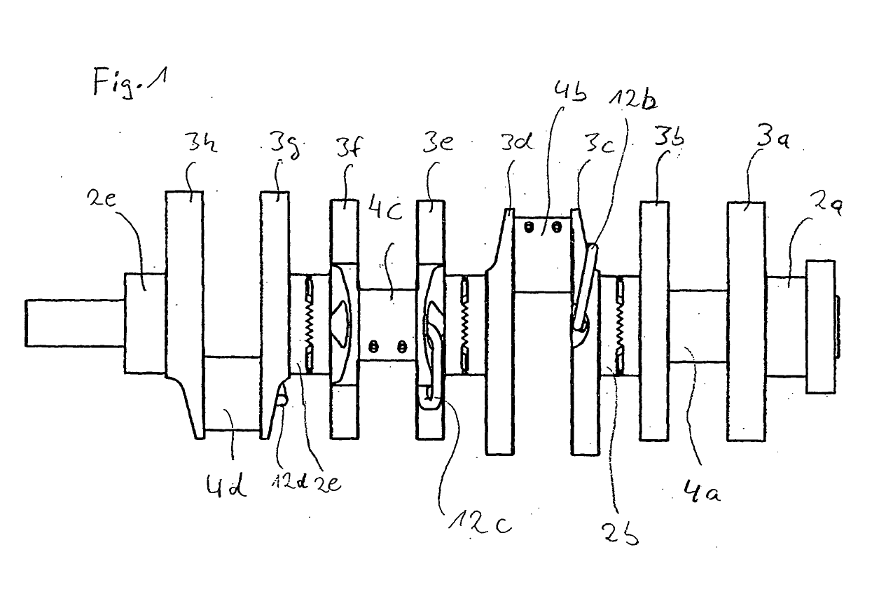

FIG. 1 shows a three-dimensional illustration of a crankshaft for an eight cylinder engine. The crankshaft 1 comprises overall five shaft journals 2a to 2e, by way of which the crankshaft 1 is mounted with sliding bearings (not shown) in an engine block (likewise not shown). In each case cheeks 3a to 3h, between which in each case crankpin journals 4a to 4d are arranged, are arranged between the shaft journals 2. The crankpin journals 4 are connected in each case to connecting rod bearings (not shown here) which are usually likewise split sliding bearings.

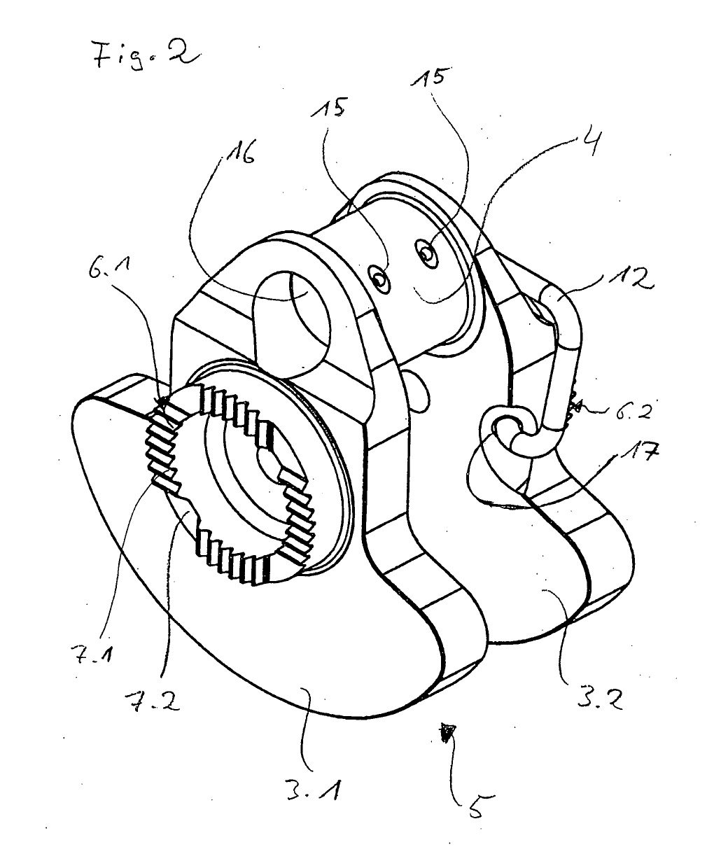

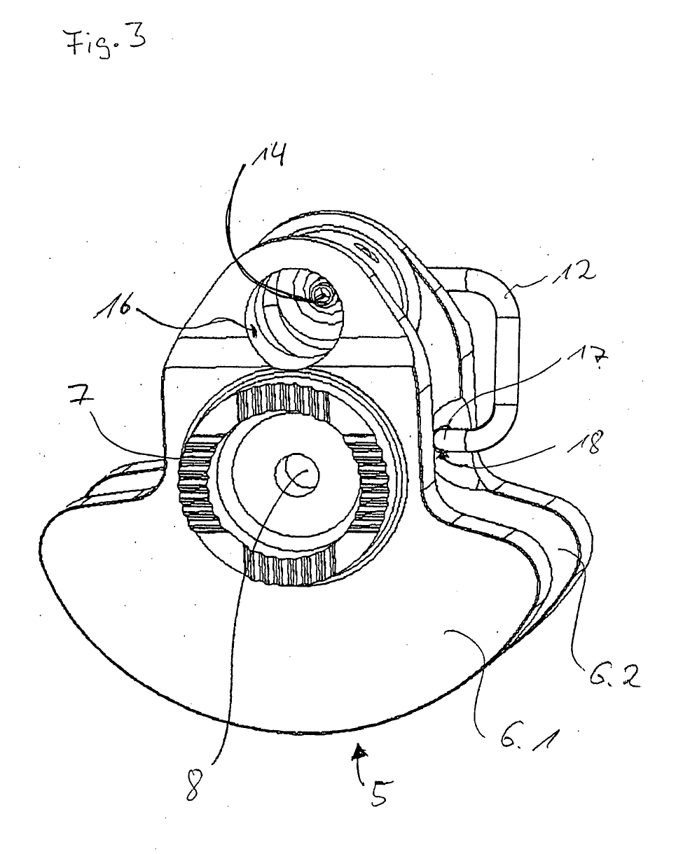

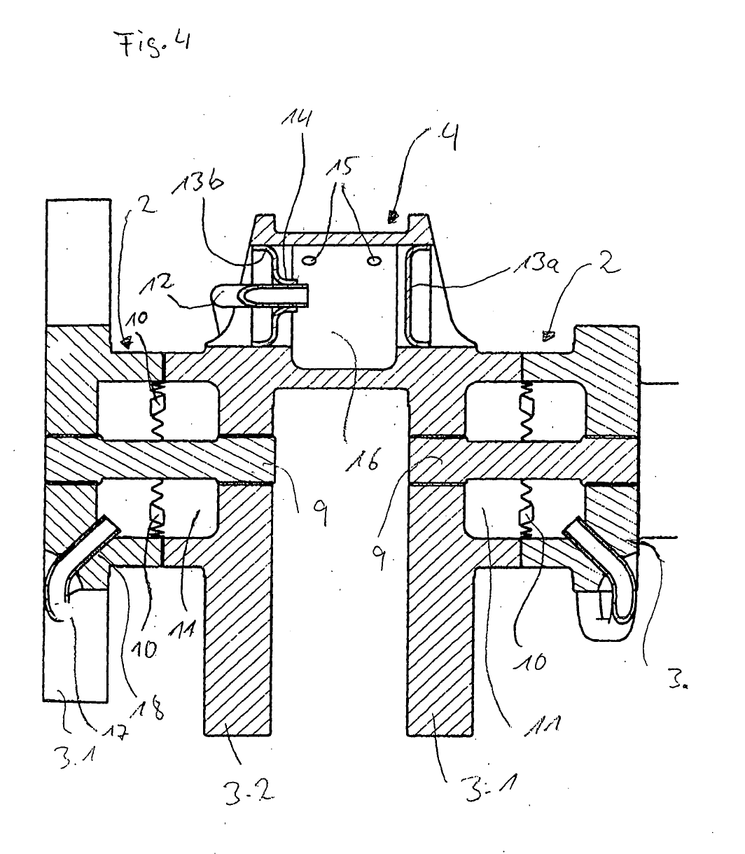

The crankshaft 1 is divided in each case along the shaft journals 2 into cheek segments 5; one of these is shown in FIG. 2. Each of the cheek segments 5 comprises in each case two cheeks; these are denoted in FIG. 2 by 3.1 and 3.2, between which a crankpin journal 4 is arranged. The crankpin journal 4 is of substantially hollow-cylindrical design and can be welded, screwed or pressed to the cheeks 3.1 and 3.2. At their axial ends, each cheek segment 5 comprises a shaft journal connection 6.1, 6.2 which in each case have toothing systems 7. The toothing systems 7 have in each case a pitch of such a type that the shaft journal connections 6.1, 6.2 fit together alternately, with the result that a plurality of cheek segments 5 can be combined at relative angles with respect to one another which are dependent on the pitch of the toothing systems 7, to form a complete crankshaft according to FIG. 1. FIG. 3 shows the illustration of FIG. 2 in a three-dimensionally rotated view, with the result that the shaft journal connection 6.1 is shown approximately in plan view. The toothing systems 7 can be seen firstly; secondly, a threaded hole 8 can be seen. The toothing systems 7 are arranged concentrically with respect to the rotational axis of the crankshaft 1 which is defined by the shaft journals 2a to 2e. The threaded holes 8 of the shaft journal connections 6.1 and 6.2 have in each case threads of different orientation; one of the threads is left-handed, and the other thread is right-handed. In this way, as shown in FIG. 4, in each case two cheeks 3.1, 3.2 can be connected to one another by means of a threaded pin 9. Each of the threaded pins 9 can be screwed on to another cheek segment, with the attachment of a cheek segment, both cheeks segments 5 being pressed onto one another by the thread which is left-handed and also right-handed. Here, the thread pairs of the threaded pin 9 with the threaded holes 8 are in each case of self-locking design, with the result that no further securing means are to be provided for the threaded pin 9. It is sufficient here if one of the thread pairs, the left-handed or right-handed one, is self-locking.

As an alternative, the right-angled bends can be connected to one another by way of a threaded pin 9 which has in each case right-handed or left-handed threads of different pitch on both sides. The overall pitch of this “differential thread” then results as the difference of both thread pitches. If, for example, one side has a pitch of 1.5 mm and the other has a pitch of 1.0 mm, the effective pitch is 0.5 mm, that is to say the distance which both parts which are to be screwed together are moved toward one another during one pin revolution.

In a further alternative, the right-angled bends can be welded to one another. As an alternative, the right-angled bends can be connected to one another in another way with a material-to-material fit, for example by soldering or adhesive bonding. Here, the toothing system can be present at least partially as an assembly aid for defining suitable angular positions of the right-angled bends with respect to one another. As an alternative, the toothing system can be omitted completely. A pin which is similar to the threaded pin 9 (for example, without a thread or with identical threads on both sides) can optionally be used as an assembly aid for centering purposes. The right-angled bends are then assembled first of all by way of the threaded pin 9, then they are welded, and then the threaded pins are removed.

As can be seen in FIG. 2, the toothing systems 7 comprise in each case toothed regions 7.1 and non-toothed regions 7.2. Oil supply openings 10 in the form of radial passages are formed in the shaft journals 2 by a suitable arrangement of the non-toothed regions, with the result that oil can penetrate from the sliding bearing, by way of which the shaft journal 2 is mounted, into the hollow space 11 which is formed by the hollow-cylindrical structure of the shaft journal. The hollow spaces 11 are then connected in each case by way of a pipe duct 12 to an associated crankpin journal 4. As shown in FIG. 1, for example, the shaft journal 2a is connected by way of a pipe duct 12a to the crankpin journal 4a, the shaft journal 2b is connected by way of a pipe duct 12b to the crankpin journal 4b, etc. For this purpose, as can be seen, for example, from FIG. 4, the crankpin journals 4 are provided with a hollow space 11, for example are drilled to be hollow, and have sealing caps 13a, 13b at both axial ends, the sealing cap 13a being closed substantially in the shape of a cup and the sealing cap 13b having a hole 14 for receiving the pipe duct 12. As can be seen, for example, from FIGS. 2 and 4, the crankpin journals 4 comprise, in a manner which is known per se, a plurality of radial holes 15 which connect a crankpin journal hollow space 16 which is formed by the substantially hollow-cylindrical crankpin journals 4 and the sealing caps 13 to the sliding bearing between the crankpin journal 4 and the connecting rod (not shown). In FIGS. 2 and 4, in each case two radial holes 15 are made in the crankpin journals 4, as in each case two connecting rods act on each crankpin journal (eight cylinder engine, crankshaft having four right-angled bends).

As can be seen, for example, from FIG. 2, the pipe ducts 12 could open into the hollow space 11 almost as desired. An opening 17 into the hollow space 11 is preferably arranged in such a way that they lie outside regions of the cheeks 3 which lie in the force flow between the crankpin journal 4 and the shaft journal 2. The opening 17 which is made as a through hole 18 in the cheeks 3, as can be gathered, for example, from FIG. 4, therefore does not weaken the crankshaft.

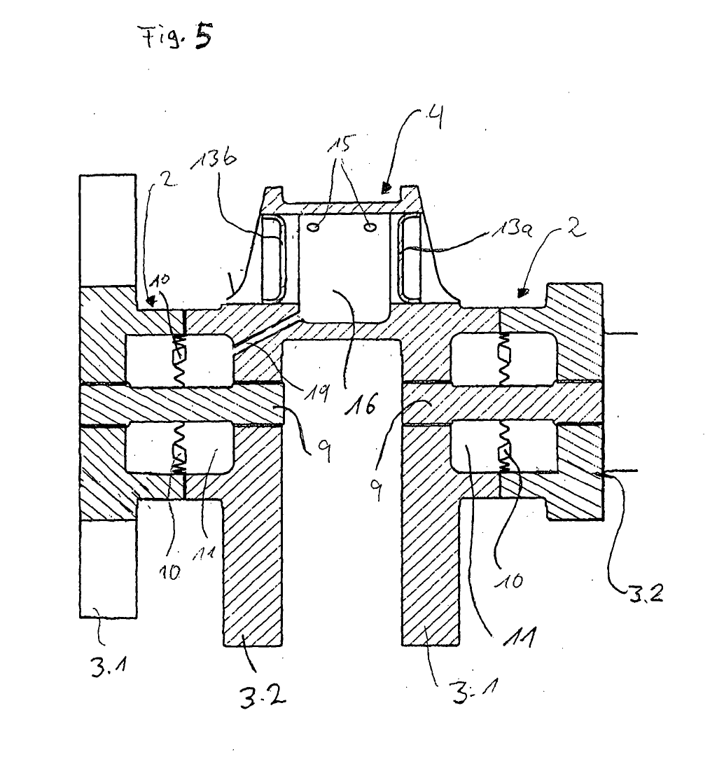

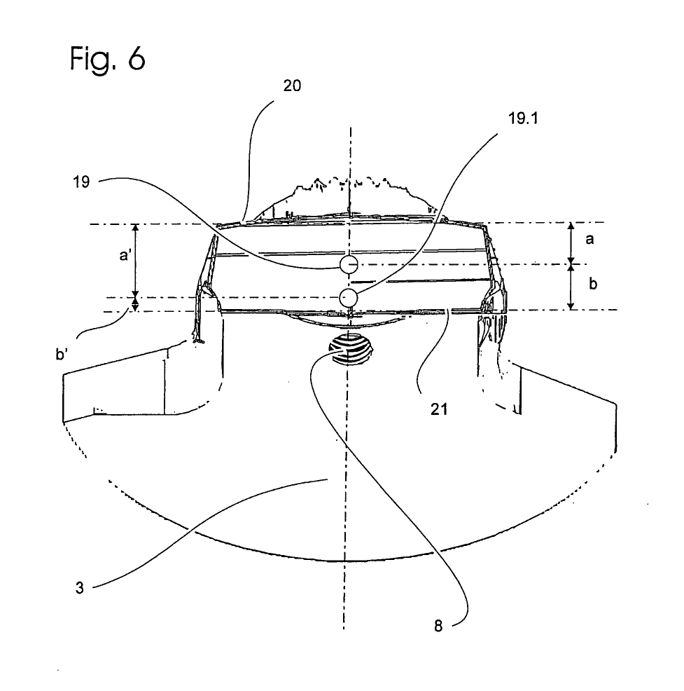

As an alternative, a hole 19 according to FIG. 5 and FIG. 6 can be routed into the crankpin journal hollow space 16 from the hollow space 11 through the cheek, here, for example, the cheek 3.2. As can be gathered from FIG. 6, the hole lies centrally in the cross section. This is possible, since the holes are made before assembly of the individual cheek segments 5. In the case of holes according to the prior art, they have to be arranged in such a way that at least the inlet hole is accessible from the outside. If the inlet and outlet holes are to be deburred, they both have to be accessible. In the case of crankshafts according to the prior art, the holes 19 therefore lie eccentrically, as is shown in FIG. 6 as hole 19.1 with the spacings a′ and b′ from the outer edges 20 and 21. The section modulus against bending is weakened by a hole near the upper or lower region of the cross section. A hole in the center is therefore the least dangerous. In the case of the crankshaft which is screwed or welded according to the invention, the holes 19 are preferably arranged centrally, and the spacings a and b are therefore identical as measured on the radial sectional face. As the hole 19 is made before assembly of the cheeks, it can be deburred without problems, as it is largely freely accessible.

### LIST OF DESIGNATIONS

1 Crankshaft
2a-2e Shaft journals
3a-3h Cheeks
4a-4d Crankpin journals
5 Cheek segment
6.1 Shaft journal connection
6.2
7 Toothing system
7.1 Toothed region
7.2 Non-toothed region
8 Threaded hole
9 Threaded pin
10 Oil supply opening
11 Hollow space
12a-12d Pipe ducts
13a, 13b Sealing cap
14 Hole for receiving the pipe duct
15 Radial hole
16 Crankpin journal hollow space
17 Opening into hollow space 11
18 Through hole
19 Hole for connecting hollow space 11 to crankpin hollow space 16

1. A crankshaft for an internal combustion engine, comprising at least one crankpin journal which is arranged between two cheeks which re connected in each case to a shaft journal, characterized in that both the crankpin journal and at least one of the shaft journals have hollow spaces, the hollow spaces being connected to one another by means of a pipe duct which extends substantially outside the cheeks.

2. The crankshaft as claimed in claim 1, characterized in that it comprises a plurality of right-angled bends having in each case one cheek, one crankpin journal and a further cheek, the right-angled bends being screwed to one another in each case and each hollow space of a crankpin journal being connected to a hollow space of a shaft journal by means of a pipe duct.

3. The crankshaft as claimed in claim 2, characterized in that the right-angled bends comprise in each case one shaft journal connection, regions of the shaft journal connection being provided with toothing systems which correspond with one another, and other regions of the shaft journal connection being without toothing, with the result that the regions without toothing form oil supply openings between hollow spaces of the shaft journals and the outer faces of the shaft journals.

4. The crankshaft as claimed in claim 3, characterized in that the right-angled bends are connected to one another by way of a threaded pin which has a right-handed thread on one axial side and a left-handed thread on the other side.

5. The crankshaft as claimed in claim 1 or 4, characterized in that the right-angled bends are connected to one another by way of a threaded pin which has in each case right-handed or left-handed threads of different pitch on both sides.

6. The crankshaft as claimed in claim 5, characterized in that at least one of the threads of the threaded pin is self-locking.

7. The crankshaft as claimed in claim 1 or 4, characterized in that the pipe duct opens into the shaft journal outside the force flow of the cheeks.

8. The crankshaft as claimed in claim 1 or 4, characterized in that the pipe duct opens into the crank journal outside a surface which represents the intersection of two circles about the rotational axes of the crank journal and the shaft journal with the radius of the spacing between the two axes.

9. The crankshaft as claimed in claim 1 or 4, characterized in that the pipe duct opens into a sealing cap of the crank journal.

10. The crankshaft as claimed in claim 1 or 4, characterized in that the pipe duct is fixed to a cheek by way of at least one holding device.

11. The crankshaft as claimed in claim 1 or 4, characterized in that the right-angled bends are welded or soldered or adhesively bonded to one another.

12. The crankshaft as claimed in claim 11, characterized in that a hole is routed from the hollow space centrally through the cheek into the crankpin journal hollow space.

13. An internal combustion engine having a crankshaft as claimed in claim 1 or 4.
